(19) United States
(12) Patent Application Publication
(10) Pub. No.: US 2009/0145719 A1
(43) Pub. Date: Jun. 11, 2009

(54) ONE-WAY CLUTCH OF SPRAG TYPE

(75) Inventors: Atsushi KARIO, Fukuroi-shi (JP); Takeshi ITOU, Fukuroi-shi (JP)

Correspondence Address: MILES & STOCKBRIDGE PC, 1751 PINNACLE DRIVE, SUITE 500, MCLEAN, VA, 22102-3833, US

(73) Assignee: NSK-WARNER K.K.

(21) Appl. No.: 12/257,051

(22) Filed: Oct. 23, 2008

(30) Foreign Application Priority Data
Dec. 7, 2007 (JP) 2007-316564

(51) Int. Cl. F16D 41/07

(52) U.S. Cl. 192/41 A

(57) ABSTRACT

The present invention provides a one-way clutch of sprag type comprising an outer race having an inner peripheral track surface, an inner race disposed within the outer race and having an annular outer peripheral track surface, the outer and inner races being disposed concentrically to be rotated relative to each other, a plurality of sprags disposed between the outer race and the inner race and adapted to transmit torque between the outer peripheral track surface and the inner peripheral track surface, a holder for holding the sprags, and a ribbon spring for biasing the sprags, and wherein the ribbon spring is constituted by side bars disposed at both axial end portions of the ribbon spring and having wrinkle portions, and cross bars extending in an axial direction and adapted to interconnect the side bars and further wherein both circumferential end portions of the ribbon spring are secured to each other.

### BACKGROUND OF THE INVENTION

1. Field of the Invention

The present invention relates to a one-way clutch of sprag type used in an automatic transmission of a motor vehicle and the like. More specifically, the present invention relates to an improvement in a ribbon spring of a one-way clutch of sprag type.

2. Related Background Art

Generally, in a stator of an automatic transmission of a motor vehicle, a one-way clutch of roller type in which rollers are used as torque transmitting members is utilized. In comparison with a one-way clutch of sprag type, the one-way clutch of roller type has an advantage that a manufacturing cost is low but also has a disadvantage that engagement is less reliable. That is to say, if there is partial miss-engagement in rollers, some of rollers engaged causes eccentricity between inner and outer races, with the result that legs provided on an inner diameter portion of the outer race at the miss-engagement side are strongly urged against a track surface of the inner race, so that the one-way clutch is secured or seized by the strong contact force.

On the other hand, Japanese Patent Application Laid-open No. 63-259225 (1988) discloses a one-way clutch of sprag type having a dual holder used in a stator. In this clutch, although reliability of engagement thereof is high in comparison with a one-way clutch of roller type generally used in a stator, a manufacturing cost thereof is also high.

In recent years, reduction of cost has been requested more and more, and, thus, an inexpensive one way clutch having high reliability has been requested.

In conventional one-way clutches of sprag type, in order to engage sprags with track surfaces of inner and outer races, it is desired to enhance reliability of a spring for giving rising moment to the sprags.

In the above-mentioned Japanese Patent Application Laid-open No. 63-259225, a spring is arranged in an annular fashion. However, since both ends of the spring are not fixed or secured, a sprag holding function of the spring is poor, with the result that it is feared that adequate moment cannot be applied to the sprags. Further, in Japanese Patent Application Laid-open No. 2004-68832, a spring is stabilized by overlapping both ends of the spring. However, the both ends of the spring are not fixed.

From the above explanation, the springs disclosed in the above-mentioned Japanese Patent Application Laid-open No. 63-259225 and Japanese Patent Application Laid-open No. 2004-68832 can not always provide desired reliability.

### SUMMARY OF THE INVENTION

Accordingly, an object of the present invention is to provide a one-way clutch of sprag type suitable to use in a stator of a torque converter, which is cheap and has reliability in engagement.

To achieve the above object, the present invention provides a one-way clutch of sprag type comprising an outer race having an inner peripheral track surface, an inner race disposed within the outer race and having an annular outer peripheral track surface, the outer and inner races being disposed concentrically to be rotated relative to each other, a plurality of sprags disposed between the outer race and the inner race and adapted to transmit torque between the outer peripheral track surface and the inner peripheral track surface, a holder for holding the sprags, and a ribbon spring for biasing the sprags, and wherein the ribbon spring is constituted by side bars disposed at both axial end portions of the ribbon spring and having wrinkle portions, and cross bars extending in an axial direction and adapted to interconnect the side bars and further wherein both circumferential end portions of the ribbon spring are secured to each other.

According to the one-way clutch of sprag type of the present invention, the following effects can be obtained. By securing the both circumferential end portions of the spring having the wrinkle portions, even if an outer holder is eliminated, similar to a one-way clutch of sprag type having a dual holder, all of the sprags disposed along the circumferential direction can be biased uniformly or evenly in an engaging direction by tabs of the spring

Further, due to moment applied to each sprag, the one-way clutch is idly rotated together with the outer race during a high speed idle rotation, similar to a clutch of sprag type having the dual holder. The holder disposed at the inner diameter side of the ribbon spring can serve to prevent rotations or excessive swinging movements of the sprags by its pockets if the sprags are slipped due to miss-engagement, thereby preventing deformation and/or damage of the ribbon spring.

Further, the holder disposed at the inner diameter side can serve to synchronize the movements of the sprags arranged along the circumferential direction thereby to produce a full-fazing effect upon engagement, thereby maintaining reliability of the engagement. Further, when the inner race is inserted into the one-way clutch assembled to the outer race, since all of the sprags can be inclined toward the idle rotation side in synchronous with the movements of the sprags, the assembling ability of the inner race can be enhanced.

By designing so that the wrinkle portions of the ribbon spring have convex configurations protruding toward the outer diameter side, different from convex wrinkle portions protruded downwardly in conventional clutches of sprag type having dual holders, since the wrinkle portions are not slidingly contacted with the outer diameter portion of the holder disposed at the inner diameter side, the wrinkle portions of the ribbon spring can be prevented from being worn and damaged. The wrinkle portions are provided to increase rigidity of the ribbon spring and to afford play for circumferential elongation and contraction to the ribbon spring.

Further, by eliminating an outer holder, reduction in cost can be achieved, and, thus, a cheap and more reliable one-way clutch of sprag type which is apt to be assembled as a one-way clutch for a stator of a torque converter can be provided.

Both end portions of the ribbon spring can be joined by welding on the cross bar of the ribbon spring in a condition that the both axial end side bars are overlapped with each other. The upper side bars are cut at a circumferential end of the cross bar and the lower side bars are cut at a position exceeding a circumferential end of the cross bar. By overlapping these upper and lower side bars, the joining portion becomes an arc configuration, thereby facilitating the welding operation.

Further, by welding the cross bars having no tab, it is possible to isolate a stress generating position where stress is generated by deformation of the tab for giving the engaging force to the sprag from welding heat influenced positions. A fatigue life of the ribbon spring 6 can be extended. By designing so that a circumferential width of the cross bar having no tab becomes greater than that of the cross bar having the tab, the welding operation can be facilitated and is reliable.

Further, the ribbon spring having the both circumferential end portions joined together can be applied to a ribbon spring having cross bars including only wrinkle portions or an outer holder type in which a ribbon spring is disposed at an inner diameter side of the holder.

The joining of the both end portions of the ribbon spring may be achieved by electric spot welding, laser welding, brazing, soldering, adhesive securing or the like. Among them, the electric spot welding is most desirable in view of cost, reliability and workability.

Further features of the present invention will become apparent from the following description of exemplary embodiments with reference to the attached drawings.

### BRIEF DESCRIPTION OF THE DRAWINGS

FIG. 1 is a partial radial sectional view of a one-way clutch of sprag type according to a first embodiment of the present invention.

FIG. 2 is a partial radial sectional view of a one-way clutch of sprag type according to a second embodiment of the present invention.

FIG. 3 is a partial perspective view of a ribbon spring used in the first and second embodiments of the present invention.

FIG. 4 is a partial perspective view of an alteration of the ribbon spring used in the first and second embodiments of the present invention.

### DETAILED DESCRIPTION OF THE INVENTION

Now, embodiments of the present invention will be fully explained with reference to the accompanying drawings. Incidentally, it should be noted that the illustrated embodiments are merely examples of the present invention and other modifications and alterations can be made within the scope of the present invention.

### First Embodiment

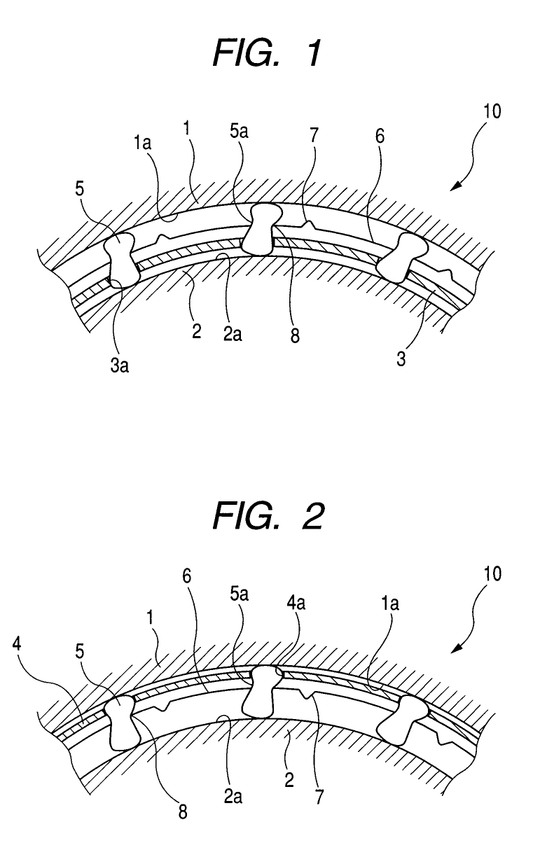

FIG. 1 is a partial radial sectional view of a one-way clutch of sprag type according to a first embodiment of the present invention. The one-way clutch 10 of sprag type comprises an outer race 1 having an inner peripheral track surface 1a, an inner race 2 disposed within the outer race 1 and having an annular outer peripheral track surface 2a, the outer and inner races being spaced apart from each other in a radial direction and disposed to be rotated relative to each other in a concentric fashion, a plurality of sprags 5 disposed between the outer race 1 and the inner race 2 and adapted to transmit torque between the outer peripheral track surface 2a and the inner peripheral track surface 1a, a holder 3 for holding the sprags 5, and a ribbon spring 6 for biasing the sprags 5 in a direction where the sprags are engaged with the outer peripheral track surface 2a and the inner peripheral track surface 1a.

The substantially annular holder 3 disposed in an annular space defined between the outer race 1 and the inner race 2 has pockets 3a arranged equidistantly in a circumferential direction and extending through the holder in the radial direction. The sprags 5 are disposed in the respective pockets 3a. The holder 3 is disposed at an inner diameter side of the ribbon spring 6.

In correspondence to the pockets 3a of the holder 3, the ribbon spring 6 disposed at an outer diameter side of the holder 3 also has pockets 8 extending through the ribbon spring in the radial direction to accommodate the sprags 5 and arranged equidistantly in the circumferential direction.

As shown in FIG. 1, at a substantially central portion in the radial direction, the sprag 5 is provided with a neck portion 5a having a circumferential width smaller than those of both ends of the sprag. An inner diameter side end portion of each sprag 5 is housed in the corresponding pocket 3a of the holder 3. The neck portion 5a of each sprag 5 is housed in the corresponding pocket 8 of the ribbon spring 6.

The ribbon spring 6 is provided with wrinkle portions 7 protruding radially outwardly i.e. protruding toward the outer race 1 and arranged equidistantly in the circumferential direction. By providing the wrinkle portions 7 each having a protruded portion protruding toward the outer diameter side, the wrinkle portions 7 are not slidingly contacted with an outer diameter surface of the holder 3, thereby preventing the wear and damage of the ribbon spring 6. The wrinkle portions 7 serve to increase rigidity of the ribbon spring 6 and to afford play for circumferential elongation and contraction to the ribbon spring.

In the first embodiment, by providing the holder 3 at the inner diameter side of the ribbon spring 6, movements of the sprags 5 can be synchronized, thereby enhancing an engaging ability of the one-way clutch and an assembling ability of the one-way clutch to the inner race.

### Second Embodiment

FIG. 2 is a partial radial sectional view of a one-way clutch of sprag type according to a second embodiment of the present invention. A fundamental construction of the second embodiment is similar to that of the first embodiment. However, the second embodiment differs from the first embodiment with respect to a position of a holder 4.

A substantially annular holder 4 disposed in an annular space defined between the outer race 1 and the inner race 2 has pockets 4a arranged equidistantly in the circumferential direction and extending through the holder in the radial direction. An outer diameter end portion of each sprag 5 is held in the corresponding pockets 4a. The holder 4 is disposed at an outer diameter side of the ribbon spring 6.

In the second embodiment, since wrinkle portions 7 of the ribbon spring 6 do not abut against an inner diameter surface of the holder 4, the ribbon spring 6 can be prevented from being worn and damaged due to the sliding contact of the ribbon spring.

Since an outer holder is not required in the first embodiment and an inner holder is not required in the second embodiment, reduction in cost can be achieved, and, thus, a cheap and reliable one-way clutch of sprag type which is apt to be assembled as a one-way clutch for a stator of a torque converter can be provided.

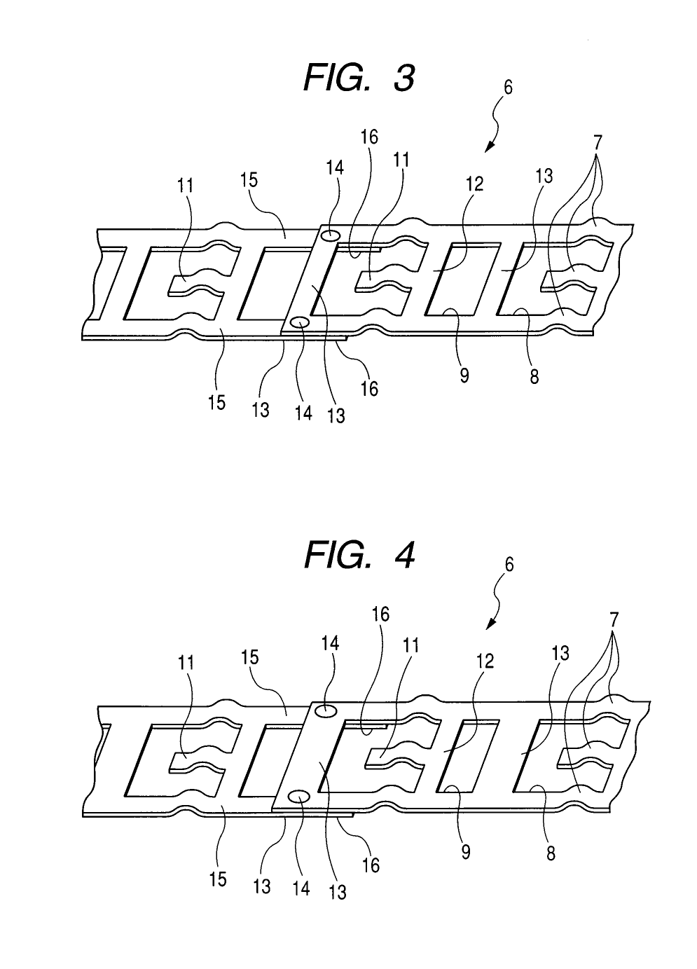

FIG. 3 is a partial perspective view of the ribbon spring 6 shown in the first and second embodiments, illustrating a construction of the ribbon spring 6 in detail. Although the ribbon spring 6 is actually formed in an annular shape in use, here, for convenience's sake, the ribbon spring is shown in a substantially flat shape. The ribbon spring 6 is constituted by side bars 15 disposed at both axial ends of the ribbon spring and wrinkle portions, first cross bars 12 extending in the axial direction and adapted to interconnect the side bars 15 and second cross bars 13 extending in the axial direction and adapted to interconnect the side bars.

Each first cross bar 12 has a tab 11 extending from a substantially axial central portion of the cross bar along the circumferential direction in a corresponding pocket 8. On the other hand, each second cross bar 13 has no tab. In the ribbon spring 6, pockets 8 and pockets 9 which extending through the ribbon spring in the radial direction are provided equidistantly in the circumferential direction. The pockets 8 and the pockets 9 are arranged alternately along the circumferential direction. The sprags 5 are housed in the pockets 8 and the pockets 9 are vacant. Further, since the neck portion 5a of the sprag 5 held in the pocket 8 is contacted with the tab 11, rising moment for engaging the sprag with the outer race 1 and the inner race 2 is afforded to the sprag by the ribbon spring 6.

Two wrinkle portions 7 provided on the side bars 15 disposed at the both axial ends of the ribbon spring 6 and the wrinkle portion 7 provided on the tab 11 are positioned at the same location in the circumferential direction (aligned in the axial direction).

The ribbon spring 6 has a substantially annular shape with both circumferential end portions secured together. As shown in FIG. 3, one end portion of the ribbon spring 6 is constituted by the second cross bar 13 having no tab 11 and the other end portion is constituted by the second cross bar 13 and extensions 16 of the side bars 15.

The both end portions of the ribbon spring 6 are fixedly secured to each other as follows. The second bars 13 of the both end portions of the ribbon spring 6 are overlapped with each other. As a result, the extensions 16 of the side bars 15 are also overlapped with the side bars 15 of the other end portion.

In such an overlapped condition, the both end portions of the ribbon spring are joined and secured to each other at both axial ends of the second cross bars 13 and on the side bars 15 (joining portions 14). As a result, the ribbon spring 6 is constructed as a substantially annular member.

The joining of the both end portions of the ribbon spring may be achieved by electric spot welding, laser welding, brazing, soldering, adhesive securing or the like. Among them, the electric spot welding is most desirable in view of cost, reliability and workability.

By securing the ribbon spring by joining the second cross bars 13 having no tab 11, it is possible to isolate a stress generating position where stress is generated by deformation of the tab 11 for giving the engaging force to the sprag 5 from welding heat influenced positions. In other words, since the stress generating position is spaced apart from the welded portions, the stress generating position can be protected from the influence of the welding heat. Further, a fatigue life of the ribbon spring 6 can be extended.

FIG. 4 is a partial perspective view of the ribbon spring 6 shown in the first and second embodiments, illustrating an alteration of the ribbon spring 6 shown in FIG. 3. Since a fundamental construction of the ribbon spring of FIG. 4 is the same as the ribbon spring 6 of FIG. 3, only a difference will be explained.

Similar to FIG. 3, both end portions of the ribbon spring 6 are fixedly joined in a condition that the second cross bars 13 are overlapped with each other. However, in FIG. 4, a circumferential width of each second cross bar 13 is greater than that of the first cross bar 12 having the tab 11. With this arrangement, the joining operations at the joining portions 14 can be facilitated and the joining operation can be performed positively.

In the above-mentioned embodiments and alteration thereof of the one-way clutch of sprag type of the present invention, various modifications and alterations can be made. For example, while an example that the joining portions 14 are located on the side bars 15 was explained, the joining portions may be located only on the second cross bar 13, rather than the side bars 15.

Further, the number of the joining portions 14 is voluntary, and, thus, three or more joining portions may be provided. For example, in FIGS. 3 and 4, an additional joining portion 14 may be added at a substantially central portion of the second cross bar 13 so that three joining portions 14 are provided. Further, in addition to the joining portions 14 shown in FIGS. 3 and 4, an additional joining portion 14 may be added on each of the side bars 15 overlapped with the extensions 16 so that four joining portions are provided. By increasing the number of the joining portions 14, the both end portions of the ribbon spring 6 can be secured more strongly, so that more stable operation can be expected.

Each of the wrinkle portions 7 provided at the side bars 15 and the tabs 11 may have a concave shape protruding toward the outer diameter side as shown in FIG. 1 or a concave shape protruding toward the inner diameter side as shown in FIG. 2.

The ribbon spring 6 shown in FIGS. 3 and 4 has a configuration in which the wrinkle portions 7 are protruded toward the outer diameter side, i.e. a configuration shown in FIG. 1. By protruding the wrinkle portions 7 toward the inner diameter side, the ribbon spring 6 corresponding to the second embodiment can be formed.

Further, while an example that all of the wrinkle portions 7 provided at the side bars 15 and the tabs 11 are protruded toward the same direction was explained as shown in the above-mentioned embodiments and alteration, the present invention is not necessarily limited to such an example, but the wrinkle portions 7 of the side bars 15 may be protruded toward an opposite direction to the protruding direction of the wrinkle portions 7 of the tabs 11.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. This application claims the benefit of Japanese Patent Application No. 2007-316564, filed Dec. 7, 2007, which is hereby incorporated by reference in its entirety.

What is claimed is:

1. A one-way clutch of sprag type comprising:
an outer race having an inner peripheral track surface;
an inner race disposed within said outer race and having an annular outer peripheral track surface, said outer and inner races being disposed concentrically to be rotated relative to each other;
a plurality of sprags disposed between said outer race and said inner race and adapted to transmit torque between said outer peripheral track surface and said inner peripheral track surface;
a holder for holding said sprags; and
a ribbon spring for biasing said sprags; and wherein
said ribbon spring is constituted by side bars disposed at both axial end portions of said ribbon spring and having wrinkle portions, and cross bars extending in an axial direction and adapted to interconnect said side bars;
and further wherein
both circumferential end portions of said ribbon spring are secured to each other.

2. A one-way clutch of sprag type according to claim 1, wherein said cross bars are constituted by a first cross bar having a tab including a wrinkle portion extending from said cross bar in a circumferential direction, and a second cross bar having no tab.

3. A one-way clutch of sprag type according to claim 2, wherein said wrinkle portions of said side bars and said wrinkle portion of said first cross bar are positioned at the same position in the circumferential direction.

4. A one-way clutch of sprag type according to claim 1, wherein said both circumferential end portions of said ribbon spring are secured by joining in a condition that said second cross bars and said side bars are overlapped with each other, respectively.

5. A one-way clutch of sprag type according to claim 4, wherein said both end portions of said ribbon spring are secured by joining at a position of said second cross bar.

6. A one-way clutch of sprag type according to claim 2, wherein a circumferential width of said first cross bar is greater than a circumferential width of said second cross bar.

7. A one-way clutch of sprag type according to claim 1, wherein said holder is positioned at an inner diameter side of said ribbon spring.

8. A one-way clutch of sprag type according to claim 1, wherein said holder is positioned at an outer diameter side of said ribbon spring.

9. A one-way clutch of sprag type according to claim 7, wherein said wrinkle portion of said side bar and said tab have convex configurations protruding toward the outer diameter side.

10. A one-way clutch of sprag type according to claim 8, wherein said wrinkle portion of said side bar and said tab have convex configurations protruding toward the inner diameter side.

11. A one-way clutch of sprag type according to claim 1, wherein said one-way clutch of sprag type is used in a torque converter of an automatic transmission.
